(19) United States
(12) Patent Application Publication
(10) Pub. No.: US 2025/0153316 A1
(43) Pub. Date: May 15, 2025

(54) ONE-HAND BIT RELEASING HAND TOOL

(71) Applicant: YIN-HU KO, New Taipei City (TW)

(72) Inventor: YIN-HU KO, New Taipei City (TW)

(21) Appl. No.: 19/026,368

(22) Filed: Jan. 17, 2025

Related U.S. Application Data
(63) Continuation-in-part of application No. 17/897,238, filed on Aug. 29, 2022.

(30) Foreign Application Priority Data
Aug. 31, 2021 (TW) 110132355

(51) Int. Cl. B25B 13/46; B25B 13/04; B25B 23/00

(52) U.S. Cl. CPC B25B 13/463; B25B 13/04; B25B 23/0035

(57) ABSTRACT

A one-hand bit releasing hand tool includes a hand tool main body having a first drive section, which has a first drive hole and a receiving hole with a stepped portion arranged therebetween; and a positioning and releasing assembly, which includes a positioning member disposed in the receiving hole and supported on the stepped portion to apply an action force on and thus position a bit placed into the first drive hole and a releasing member disposed in the receiving hole and reciprocally movable between a positioning position and a releasing position. When the bit is placed into the first drive hole, the releasing member moves from the releasing position to the positioning position; and when the releasing member is moved from the positioning position to the releasing position, the releasing member resists the action force of the positioning member to release the bit.

### CROSS REFERENCE TO RELATED APPLICATIONS

This is a continuation-in-part of co-pending U.S. patent application Ser. No. 17/897,238 filed on Aug. 29, 2022.

### BACKGROUND OF THE INVENTION

### (a) Technical Field of the Invention

The present invention relates generally to hand tools, and more particularly to a one-hand bit releasing hand tool.

### (b) Description of the Prior Art

For general hand tools, particularly one that allows replacement of bits, when there is already a bit of a specific type (such as a slotted bit) while replacement with a bit of a different type (such as a Phillips bit) is being attempted, the process of replacement is general such that one hand holds the hand tool, while another hand holds an outer circumferential surface of the bit that is connected to the hand tool and a force is applied to pull out and separate the slotted bit from the hand tool, and then the slotted bit is placed into a tool box and a Phillips bit is taken out and put into connection with the hand tool. Such a process of bit replacement is not very lengthy, yet tedious. Operation smoothness can be further enhanced by simplifying or shortening the process of bit replacement for hand tools, and the labor loading for such an operation could also be reduced.

Further, it is common for a hand tool operator to carry out an operation in an oil-staining environment, and it is easy for the oil to attach to the hands of the operator or the bits. In case that a hand with attached thereto holding a tool bit or the bit itself is covered with the oil, the frictional force that the hand holds the bit is insufficient (meaning the bit cannot be held in a secured manner, and can be easily skid) so that the operator cannot remove the bit from the hand tool, making it hard for the operator to replace the bit.

Further, it is also often that the operator who operates the hand tool hold the hand tool with one hand, while holding another object with another hand, and consequently, this becomes a problem as replacing the bit is hard to perform.

### SUMMARY OF THE INVENTION

In view of the above, in order to improve the problems of poor operation smoothness resulting from the lengthiness of the conventional hand tool bit replacement process, infeasibility of bit replacement carried out with one single hand for the conventional hand tools and un-performability of bit replacement for situations of both hands holding objects, and hard detachment of a bit from a hand tool in situations that either hands or the bits are attached with oil stains, the present invention aims to provide a one-hand bit releasing hand tool, which comprises: a hand tool main body, which comprises a grip section and a first drive section connected to one end of the grip section, the first drive section being inwardly recessed, in one side thereof, to form a first drive hole, the first drive section being inwardly recessed, in an opposite side thereof, to form a receiving hole, the receiving hole and the first drive hole being coaxial and in communication with each other, a stepped portion being formed at a connection between hole walls of the first drive hole and the receiving hole; and a positioning and releasing assembly, which comprises a positioning member and a releasing member, the positioning member being disposed in the receiving hole of the hand tool main body and in contact with and supported on the stepped portion to apply an action force on the bit placed into the first drive hole for positioning, the releasing member being disposed in the receiving hole and reciprocally movable between a positioning position and a releasing position upon being acted on by an external force; wherein when the bit is placed into the first drive hole, the releasing member is caused to move from the releasing position to the positioning position; and when the releasing member is acted upon by the external force to move from the positioning position to the releasing position, the releasing member resists the action force of the positioning member to cause the bit to move out of and detach from the first drive hole. As such, the present invention allows an operation of bit replacement that is performed in a manner of being not contacting the bit and manipulated with one single hand, so as to simplify a process of operation, enhance operation smoothness, and improve operation easiness.

The present invention also provides a one-hand bit releasing hand tool, which comprises: a hand tool main body, which comprises a wrenching member and a ratchet base, the wrenching member comprising a grip section, a third drive section connected to one end of the grip section, a mounting hole formed in and penetrating through the third drive section, a push bar being arranged on an outside surface of the third drive section, a control member being provided on a hole wall of the mounting hole and in operative connection with the push bar, the ratchet base being disposed in the mounting hole, a driven member being arranged on an outer circumferential surface of the ratchet base, the driven member being in engagement with the control member to control a rotation direction of the ratchet base, the ratchet base being inwardly recessed, in one side thereof, to form a second drive hole, an opposite side of the second drive hole being inwardly recessed to form a second receiving hole, the second receiving hole and the second drive hole being coaxial and in communication with each other, a second stepped portion being formed at an interface between a hole wall of the second drive hole and a hole wall of the second receiving hole; and a positioning and releasing assembly, which comprises a positioning member and a releasing member, the positioning member being disposed in the second receiving hole of the ratchet base and supported on the second stepped portion, the positioning member applying a force to a bit received in the second drive hole to hold the bit in position, the releasing member being disposed in the second receiving hole and reciprocally movable between a positioning position and a releasing position upon being acted on by an external force;

wherein when the bit is placed into the second drive hole, the releasing member is caused to move from the releasing position to the positioning position; and when the releasing member is acted upon by the external force to move from the positioning position to the releasing position, the releasing member resists the force of the positioning member so as to cause the bit to move out of and detach from the second drive hole. As such, the present invention allows an operation of bit replacement that is performed in a manner of being not contacting the bit and manipulated with one single hand, so as to simplify a process of operation, enhance operation smoothness, and improve operation easiness.

### BRIEF DESCRIPTION OF THE DRAWINGS

FIG. 1 is an exploded view showing a first preferred embodiment according to the present invention.

FIG. 2 is a perspective view showing the embodiment of FIG. 1 in an assembled form.

FIGS. 3-6 are schematic views demonstrating operation of the embodiment shown in FIG. 1.

FIG. 7 is an exploded view showing a second preferred embodiment according to the present invention.

FIG. 8 is a perspective view showing the embodiment of FIG. 7 in an assembled form.

FIG. 9 is a cross-sectional view of FIG. 8.

### DETAILED DESCRIPTION OF THE PREFERRED EMBODIMENTS

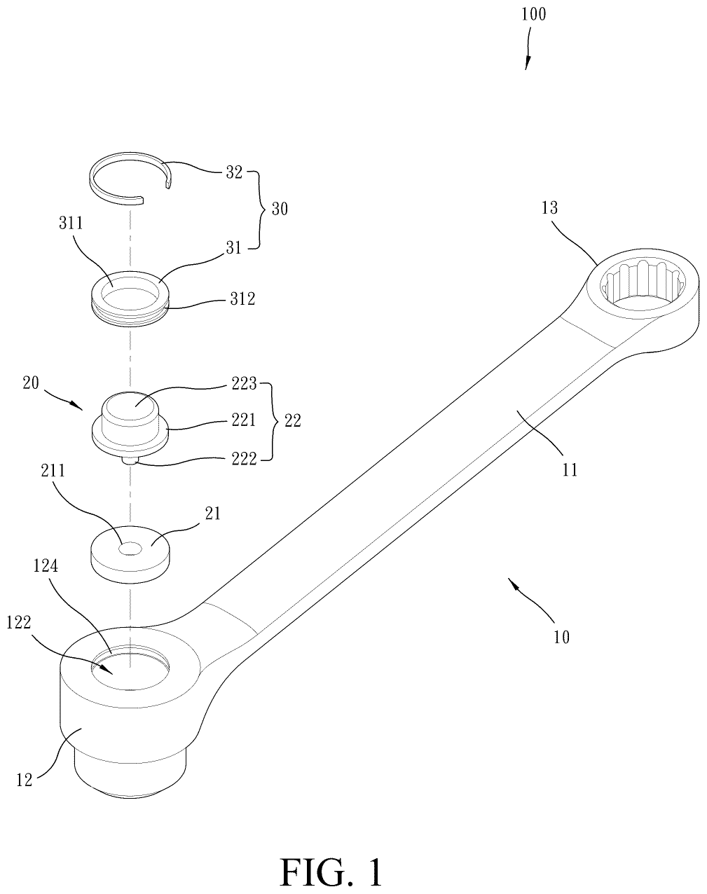

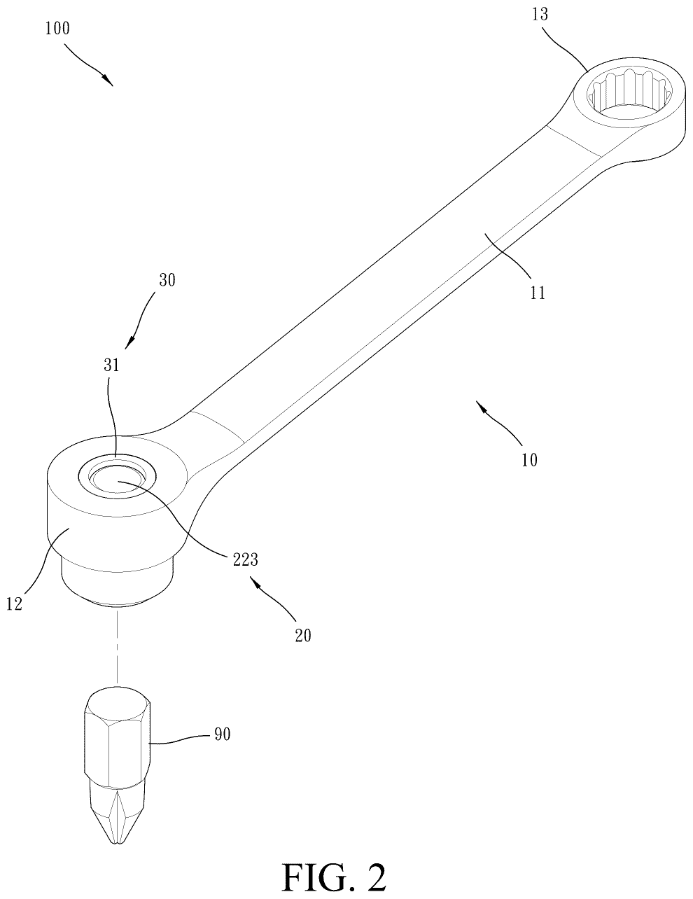

Referring to FIGS. 1-6, a one-hand bit releasing hand tool 100 according to a first preferred embodiment of the present invention mainly comprises a hand tool main body 10, a positioning and releasing assembly 20, and a constraining device 30.

Referring to FIGS. 1-3, the hand tool main body 10 comprises a grip section 11, a first drive section 12 integrally combined with one end of the grip section 11, and a second drive section 13 integrally combined with an opposite end of the grip section 11. The grip section 11 is provided for being held by a hand of an operator. The first drive section 12 is inwardly recessed, in one side thereof, and extended to form a first drive hole 121, and in the instant embodiment, the first drive hole 121 is a hexagonal hole, and the first drive section 12 is inwardly recessed, in an opposite side thereof, and extended to form a receiving hole 122, and the receiving hole 122 is extended coaxial with and in communication with the first drive hole 121, and a hole diameter of the receiving hole 122 is greater than a hole diameter of the first drive hole 121. A connection site between hole walls of the first drive hole 121 and the receiving hole 122 is formed with a stepped portion 123. A receiving hole circumferential groove 124 is formed in the hole wall of the receiving hole 122 at a portion that is adjacent to an opening.

Referring to FIGS. 1-3, the positioning and releasing assembly 20 comprises a positioning member 21 and a releasing member 22. The positioning member 21 is disposed in the receiving hole 122 of the hand tool main body 10 to apply an action to a bit 90 that is extended into the first drive hole 121 in order to implement positioning to temporarily hold the related position thereof. Ends of the bit 90 are both solid. In the embodiment, the positioning member 21 comprises a magnet. The positioning member 21, when disposed into the receiving hole 122, contacts and is supported on the stepped portion 123 to prevent falling into the first drive hole 121. The positioning member 21 is formed, in a center position thereof, with a penetrating aperture 211 that penetrates therethrough. The releasing member 22 is disposed in the receiving hole 122 of the hand tool main body 10 and is located on the positioning member 21 and is reciprocally movable, as being acted upon by an external force, between a positioning position and a releasing position. The releasing member 22 is integrally formed as a one piece. The releasing member 22 comprises a stop section 221, a push section 222 integrally combined with one end of the stop section 221, and a press section 223 integrally combined with an opposite end of the stop section 221. An outside diameter of the stop section 221 is greater than outside diameters of the push section 222 and the press section 223. The push section 222 comprises a raised peg extending through the penetrating aperture 211 of the positioning member 21 to be located in the first drive hole 121.

Referring to FIGS. 1-3, the constraining device 30 is disposed in the receiving hole 122 of the hand tool main body 10, without extending beyond the receiving hole 122, in order to prevent the positioning and releasing assembly 20 from detaching from and separating from the receiving hole 122. The constraining device 30 comprises a constraint cover 31 and a constraint cover C-clip 32. The constraint cover 31 is disposed in the receiving hole 122 and is located on the press section 223 of the releasing member 22 of the positioning and releasing assembly 20. The constraint cover 31 comprises a through hole 311 penetrating a central portion thereof. A hole diameter of the through hole 311 is greater than the outside diameter of the press section 223 and smaller than the outside diameter of the stop section 221, so that the press section 223 of the releasing member 22 is received in the through hole 311. A constraint cover circumferential groove 312 is formed in an outer circumferential surface of the constraint cover 31. The constraint cover C-clip 32 is located between a receiving hole circumferential groove 124 of the hand tool main body 10 and the constraint cover circumferential groove 312 of the constraint cover 31 in order to fix the location of the constraint cover 31 and to prevent the constraint cover 31 and the positioning and releasing assembly 20 from detaching from and separating from the receiving hole 122.

Thus, the above provides a description to the components of the one-hand bit releasing hand tool 100 according to the first preferred embodiment of the present invention and also assembly thereof, and in the following, unique advantages of operation thereof are provided:

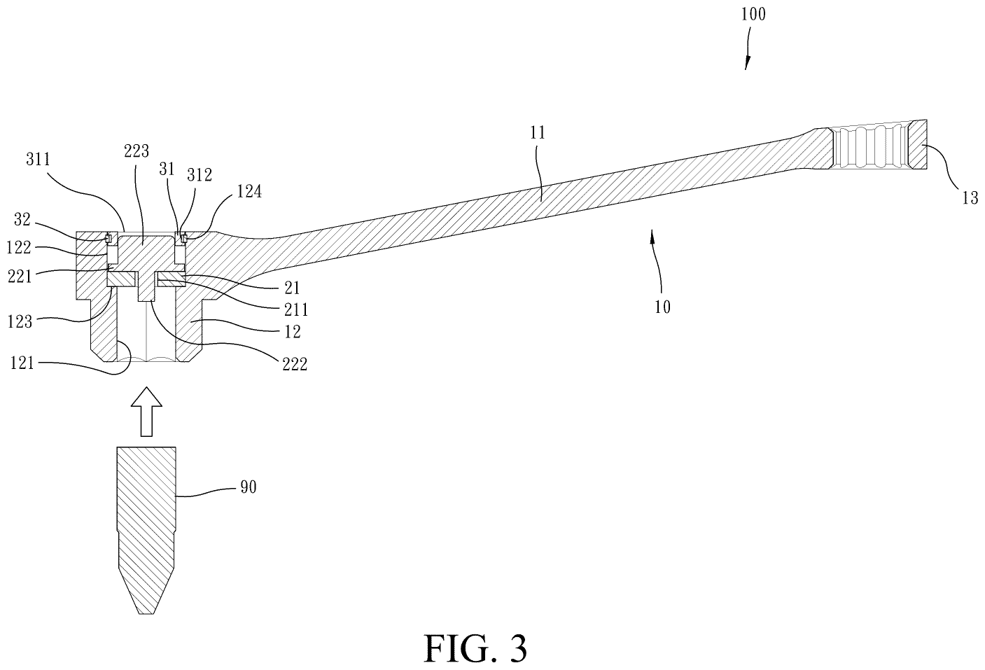

As shown in FIGS. 3-6, to connect the present invention with a bit 90, one hand of the operator grips and holds the grip section 11 of the hand tool main body 10, and another hand holds the bit 90 to place the bit 90 into the first drive hole 121 (as shown in FIG. 3); or alternatively, one hand of the operator grips and holds the grip section 11 of the hand tool main body 10 and directly moves the hand tool main body 10 so as to receive the bit 90 to directly fit into the first drive hole 121. In this way, the operator can use both hands to conduct an operation of connecting the present invention and the bit 90, or can alternatively use just one hand to conduct the operation of connecting the present invention with the bit 90, so that operation easiness and smoothness and can be greatly enhanced.

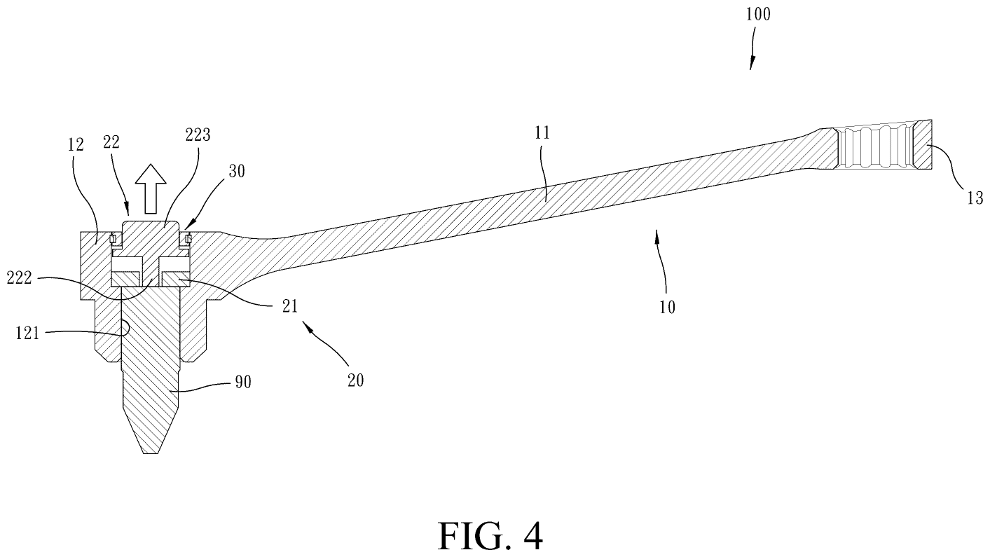

Next, after the bit 90 enters the first drive hole 121, the bit 90 is acted upon by an action force of the positioning member 21 (meaning a magnetic attractive force attracts and holds the bit 90) and thus positioned, so that the bit 90 is in contact with and supported on the positioning member 21, and also pushes upwards the push section 222 of the releasing member 22 (as shown in FIG. 4) to have the releasing member 22 pushed and moved to the positioning position, where the push section 222 is not reached into the first drive hole 121 and the press section 223 of the releasing member 22 slightly projects beyond and extends outside the receiving hole 122. At this moment, the operator may perform a desired operation with the present invention.

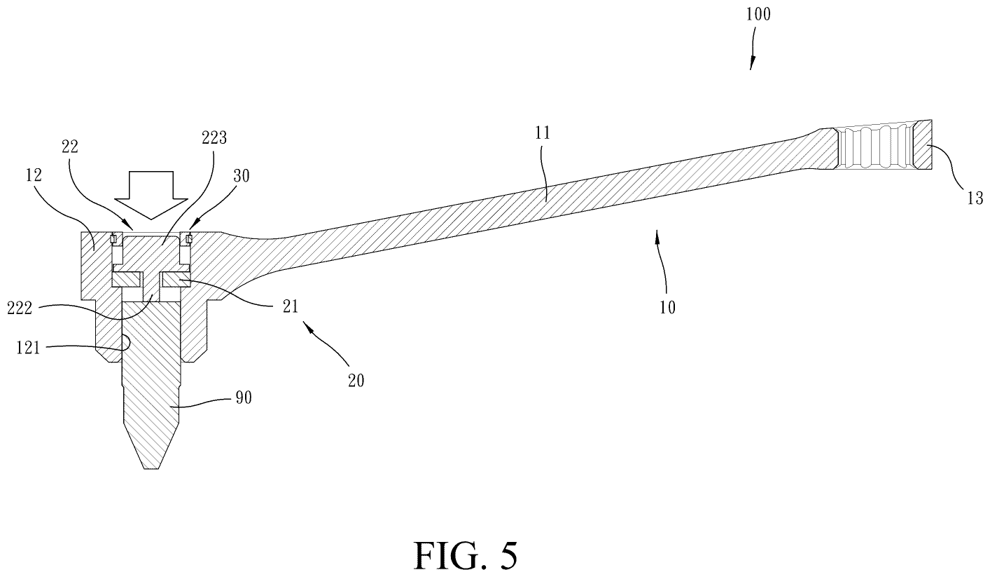

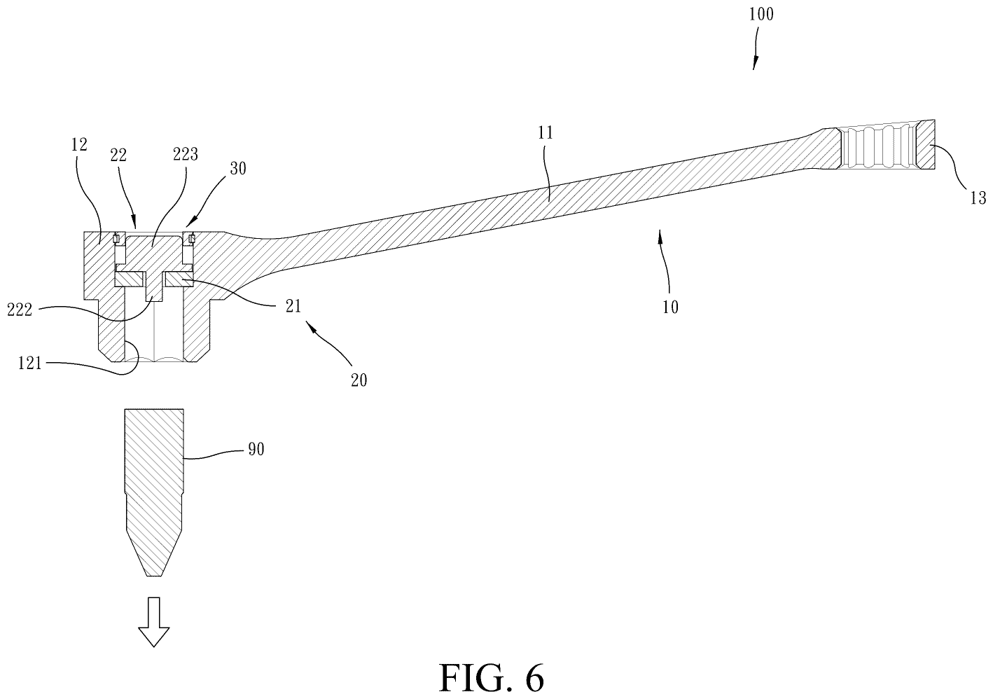

When the operator attempts to replace the bit or to detach the bit from the present invention, the operator uses the hand that grips and holds the hand tool main body 10 by reaching out one of the fingers to press on the press section 223 of the releasing member 22 (as shown in FIG. 5), so as to have the releasing member 22 moved from the positioning position to the releasing position, and thus, the push section 221 moves downward into the first drive hole 121 to resist against the magnetic attractive force applied by the positioning member 21 to thereby act on the center of an end of the bit 90 to push the bit 90 out of the first drive hole 121 (as shown in FIG. 6), and consequently completing the operation of detaching the bit 90 from the present invention. For any attempt to replace the bit, the above-described operation of connecting the bit (as shown in FIGS. 3 and 4) can then be executed.

Thus, the present invention allows for one hand operation for both connecting a bit with the present invention or detaching a bit from the present invention. The process that requires manipulation is simplified, so that operation smoothness is enhanced. Further, there is no need to put down any object from the other hand, so that the easiness of operation is enhanced. Even though the hands or the bit are stained with oil, since there is no need to contact with bit with the hands, there is no difficulty for the operation of detaching the bit.

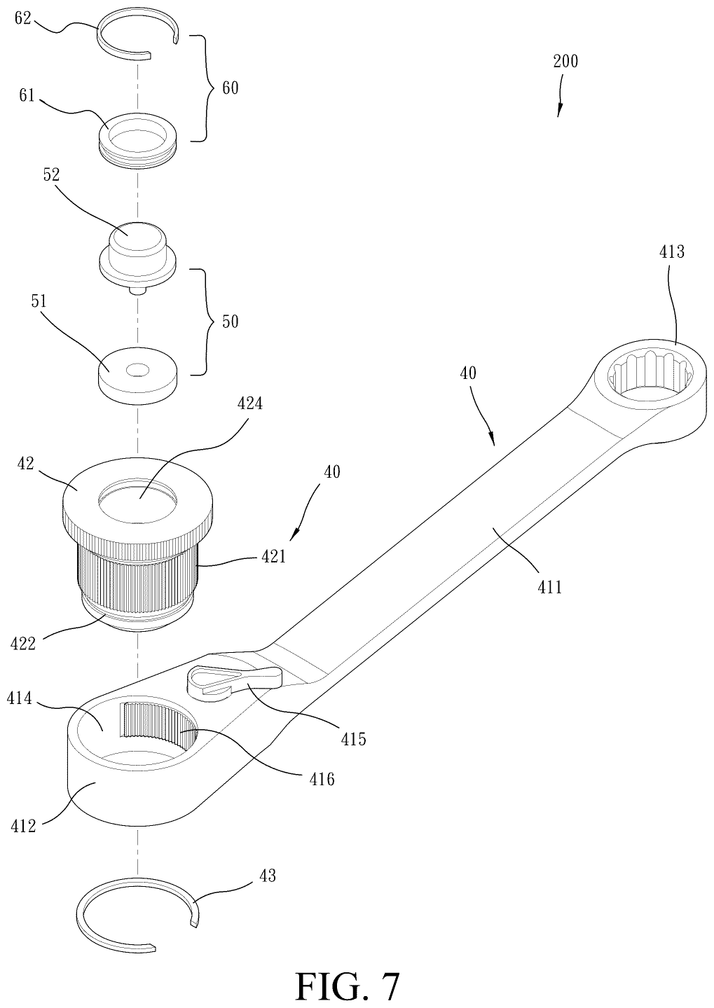

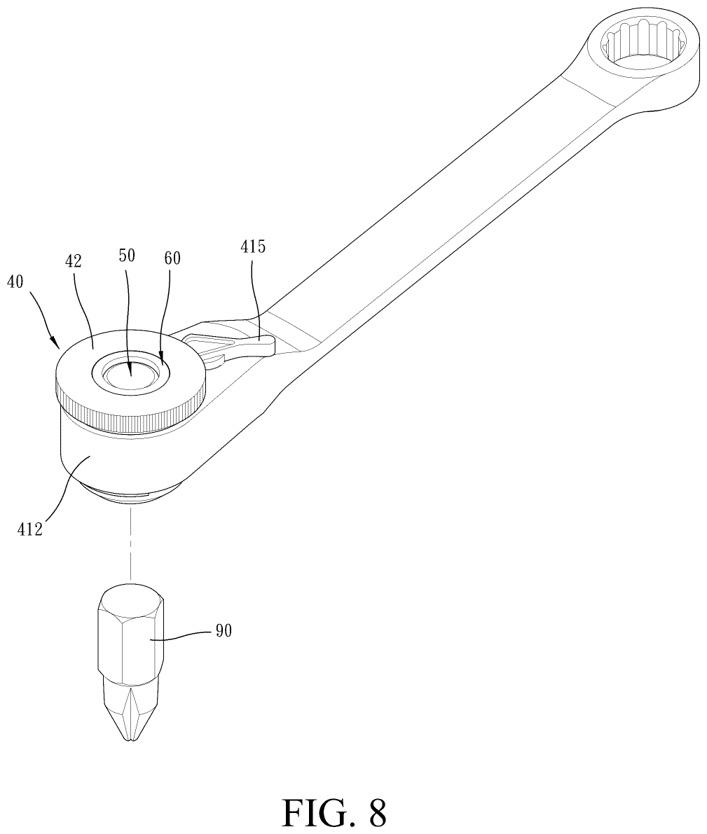

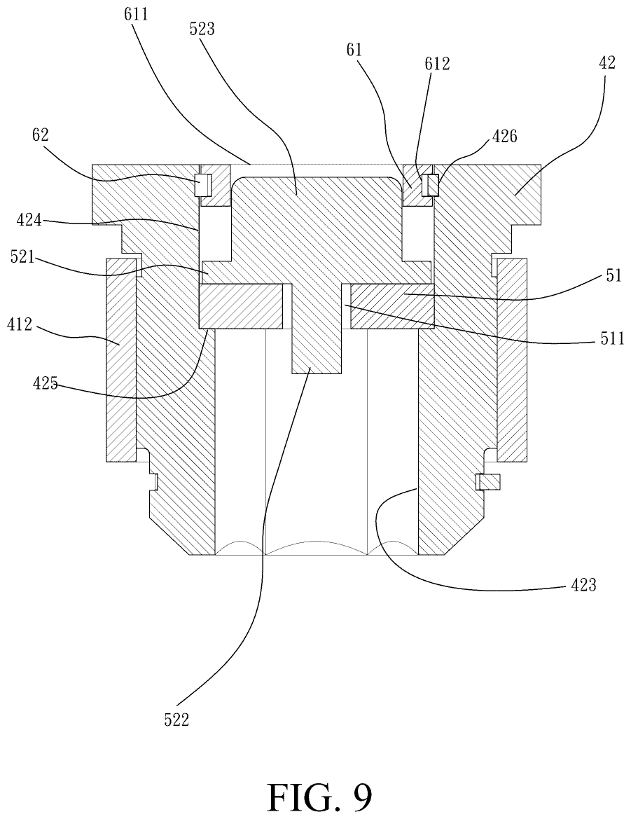

Referring to FIGS. 7-9, a one-hand bit releasing hand tool 200 according to a second preferred embodiment of the present invention is provided, which, similar to the first embodiment, comprises a hand tool main body 40, a positioning and releasing assembly 50, and a constraining device 60.

In the embodiment, the hand tool main body 40 comprises a wrenching member 41, a ratchet base 42, and a ratchet base C-clip 43. The wrenching member 41 comprises a grip section 411, a third drive section 412 integrally combined with one end of the grip section 411, and a fourth drive section 413 integrally combined with an opposite end of the grip section 411. The third drive section 412 comprises a mounting hole 414 penetrating through two opposite sides (top and bottom sides) thereof. A push bar 415 is provided on an outer surface of the third drive section 412.

A control member 416 is provided on a hole wall of the mounting hole 414 and is in operative connection with the push bar 415. The ratchet base 42 is disposed in the mounting hole 414. A driven member 421 and a ratchet base circumferential groove 422 are arranged on an outer circumferential surface of the ratchet base 42. The driven member 421 is engagement with the control member 416, so that an operator may drive the control member 416 by means of the push bar 415 to operate the driven member 421, thereby achieving an effect of controlling a rotation direction of the ratchet base 42. The ratchet base C-clip 43 is received in the ratchet base circumferential groove 422 in order to prevent the ratchet base 42 from detaching from and separating from the mounting hole 414. The ratchet base 42 is recessed and extended inward to form a second drive hole 423, and the other side of the second drive hole 423 is recessed and extended inward to form a second receiving hole 424. The second receiving hole 424 and the second drive hole 423 are coaxial with and in communication with each other. A second stepped portion 425 is formed at an interface between a hole wall or inner circumferential surface of the second drive hole 423 and a hole wall or inner circumferential surface of the second receiving hole 424. A second receiving hole circumferential groove 426 is formed in the hole wall or inner circumferential surface of the second receiving hole 424. The positioning and releasing assembly 50 and the constraining device 60 are received in the second receiving hole 424, and a bit 90 is receivable in the second drive hole 423.

Referring to FIGS. 7-9, the positioning and releasing assembly 50 comprises a positioning member 51 and a releasing member 52. The positioning member 51 is disposed in the second receiving hole 424 of the ratchet base 42 to position the bit 90 received in the second drive hole 423 for temporarily holding the bit 90 in position. In the instant embodiment, the positioning member 51 comprises a magnet. The positioning member 51 is disposed in the second receiving hole 424 and is supported on the second stepped portion 425 to prevent falling into the second drive hole 423. A penetrating aperture 511 is formed in the center of the positioning member 51 and penetrates therethrough. The releasing member 52 is disposed in the second receiving hole 424 and is located above the positioning member 51. The releasing member 52 is operable by an external force to be moved, in a reciprocal manner, between and selectively set at a positioning position and a releasing position. The releasing member 52 is integrally made as a one-piece structure. The releasing member 52 comprises a stop section 521, a push section 522 integrally combined with one end of the stop section 521, and a press section 523 integrally combined with an opposite end of the stop section 521. An outside diameter of the stop section 521 is greater than outside diameters of the push section 522 and the press section 523. The push section 522 extends through the penetrating aperture 511 of the positioning member 51 to be located in the second drive hole 423.

Referring to FIGS. 7-9, the constraining device 60 is arranged in the second receiving hole 424 of the ratchet base 42 to prevent the positioning and releasing assembly 50 from detaching from and separating from the second receiving hole 424. The constraining device 60 comprises a constraint cover 61 and a constraint cover C-clip 62. The constraint cover 61 is disposed in the second receiving hole 424 and is located above the press section 523 of the releasing member 52 of the positioning and releasing assembly 50. The constraint cover 61 comprises a through hole 611 penetrating the center thereof. A hole diameter of the through hole 611 is greater than the outside diameter of the press section 523 and smaller than the outside diameter of the stop section 521, so that the press section 523 of the releasing member 52 is received in the through hole 611. A constraint cover circumferential groove 612 is formed in an outer circumferential surface of the constraint cover 61. The constraint cover C-clip 62 is partially received in both of the second receiving hole circumferential groove 426 of the ratchet base 42 and the constraint cover circumferential groove 612 of the constraint cover 61 in order to fix the constraint cover 61 in position and to prevent the constraint cover 61 and the positioning and releasing assembly 50 from detaching from and separating from the second receiving hole 424.

In this way, the present invention realizes the same effects as those of the first embodiment, and may also control the direction of rotation to further improve the operation easiness for the operator.

I claim:

1. A one-hand bit releasing hand tool, comprising:
a hand tool main body, which comprises a wrenching member and a ratchet base, the wrenching member comprising a grip section, a third drive section connected to one end of the grip section, a mounting hole formed in and penetrating through the third drive section, a push bar being arranged on an outside surface of the third drive section, a control member being provided on a hole wall of the mounting hole and in operative connection with the push bar, the ratchet base being disposed in the mounting hole, a driven member being arranged on an outer circumferential surface of the ratchet base, the driven member being in engagement with the control member to control a rotation direction of the ratchet base, the ratchet base being inwardly recessed, in one side thereof, to form a second drive hole, an opposite side of the second drive hole being inwardly recessed to form a second receiving hole, the second receiving hole and the second drive hole being coaxial and in communication with each other, a second stepped portion being formed at an interface between a hole wall of the second drive hole and a hole wall of the second receiving hole; and
a positioning and releasing assembly, which comprises a positioning member and a releasing member, the positioning member being disposed in the second receiving hole of the ratchet base and supported on the second stepped portion, the positioning applying a force to a bit received in the second drive hole to hold the bit in position, the releasing member being disposed in the second receiving hole and reciprocally movable between a positioning position and a releasing position upon being acted on by an external force;
wherein when the bit is placed into the second drive hole, the releasing member is caused to move from the releasing position to the positioning position; and when the releasing member is acted upon by the external force to move from the positioning position to the releasing position, the releasing member resists the force of the positioning member so as to cause the bit to move out of and detach from the second drive hole.

2. The one-hand bit releasing hand tool according to claim 1, wherein the third drive section is integrally connected with the one end of the grip section; and a hole diameter of the second receiving hole is greater than a hole diameter of the second drive hole; the hand tool main body further comprises a ratchet base C-clip, a ratchet base circumferential groove being formed in the outer circumferential surface of the ratchet base, the ratchet base C-clip being received in the ratchet base circumferential groove to prevent the ratchet base from detaching from and separating from the mounting hole.

3. The one-hand bit releasing hand tool according to claim 1, wherein the positioning member comprises a magnet that applies a magnetic attractive force to the bit, and the positioning member is formed with a penetrating aperture penetrating a center thereof; the releasing member is located above the positioning member, and the releasing member comprises a stop section, a push section connected to one end of the stop section, and a press section connected to an opposite end of the stop section, an outside diameter of the stop section being greater than outside diameters of the push section and the press section, the push section being extended into the penetrating aperture of the positioning member; when the releasing member is at the positioning position, the press section protrudes out of the second receiving hole, and when the releasing member is at the releasing position, the push section extends into the second drive hole to push the bit out.

4. The one-hand bit releasing hand tool according to claim 1, further comprising a constraining device, wherein a second receiving hole circumferential groove is formed in the hole wall of the second receiving hole of the ratchet base; and the constraining device comprises a constraint cover and a constraint cover C-clip, the constraint cover being disposed in the second receiving hole and located above the press section of the releasing member, the constraint cover comprising a through hole penetrating through a center thereof, a hole diameter of the through hole being greater than the outside diameter of the press section and smaller than the outside diameter of the stop section, the press section being located in the through hole, a constraint cover circumferential groove being formed in an outer circumferential surface of the constraint cover, the constraint cover C-clip being received in both of the second receiving hole circumferential groove and the constraint cover circumferential groove to fix the constraint cover in position, in order to prevent the positioning and releasing assembly from detaching from and separating from the second receiving hole.
